(19) United States
(12) Patent Application Publication
(10) Pub. No.: US 2010/0013281 A1
(43) Pub. Date: Jan. 21, 2010

(54) Dual-seat frame of baby stroller

(76) Inventors: Hung-Tsun Chen, Taichung (TW); An-Min Hu, Taipei (TW)

Correspondence Address: Hung-Tsun Chen, P.O.Box 44-2049, Taipei, 10668, TW

(21) Appl. No.: 12/219,098

(22) Filed: Jul. 16, 2008

(51) Int. Cl. B62B 9/12

(52) U.S. Cl. 297/243

(57) ABSTRACT

A dual-baby stroller includes a main frame to which front and rear wheels are connected and two positioning members are located on two side frames of the main frame so as to be connected with a seat frame which includes two side rails which are two inverted V-shaped rails. Two front reception members are located on a front portion of the seat frame and two rear reception members are located on a rear portion of the seat frame so as to be respectively connected with the front and rear seats. Two pivotal rods are connected between the two side rails and cooperated with two pivotable units respectively such that the two pivotal rods are pivoted inward about the pivotable units. The front and rear seats can be arranged to face the same direction or to face each other.

### BACKGROUND OF THE INVENTION

(1) Field of the Invention

The present invention relates to a baby stroller, and more particularly to a dual-seat frame for a baby stroller and the two seats can be easily changed their orientations.

(2) Description of the Prior Art

A conventional dual-seat baby stroller generally includes a seat frame which is connected with two seats which are the front seat and the rear seat, the orientation of the front and rear seats cannot be adjusted and this cannot meet requirements for some users.

WO2008040797A1 discloses a seat frame for a dual-seat baby stroller and is disclosed in FIGS. 1 to 3, wherein the seat frame 10 includes two pairs of reception members so that the two seats can be connected to the seat frame 10 by inserting their inserts 11 into the reception members. The seat frame 10 includes two side rails and a connection bar 20 is connected between the two side rails by two pivotable units which allows the two side rails to be pivoted toward each other as shown in FIG. 3. Although, the seats can be conveniently connected to or disengaged from the sear frame 10, they are difficult to change their orientations. The two seats have to be removed from the seat from 10 and the seat frame 10 is then reversely re-installed to the baby stroller. The processes for removing and installing the seat frame 10 are complicated and time consuming. The two seats can only be adjusted to the same directions, either facing forward or backward. The two seats cannot be adjusted to be face to each other.

The present invention intends to provide a seat frame for dual-seat baby stroller wherein the two seats can be adjusted to face to each other without interference, and this is convenient to arrange the two babies in different ways.

### SUMMARY OF THE INVENTION

The present invention relates to a dual-baby stroller which comprises a main frame having two side frames on two sides thereof and front and rear wheels are connected to the main frame. Two positioning members are located on the two side frames so as to be connected with a seat frame. The seat frame includes two front reception members on a front portion of the seat frame and two rear reception members on a rear portion of the seat frame. The front reception members are connected with a front seat and the rear reception members are connected with a rear seat. The seat frame includes two side rails and two pivotal rods which are connected between the two side rails. The two pivotal rods are cooperated with two pivotable units respectively such that the two pivotal rods are pivoted inward about the pivotable units.

The primary object of the present invention is to provide a seat frame of a dual-seat baby stroller wherein the seat frame is an inverted V-shaped frame and the two seats can be arranged to face forward or backward individually.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows two seats to be connected to a conventional dual-seat frame;

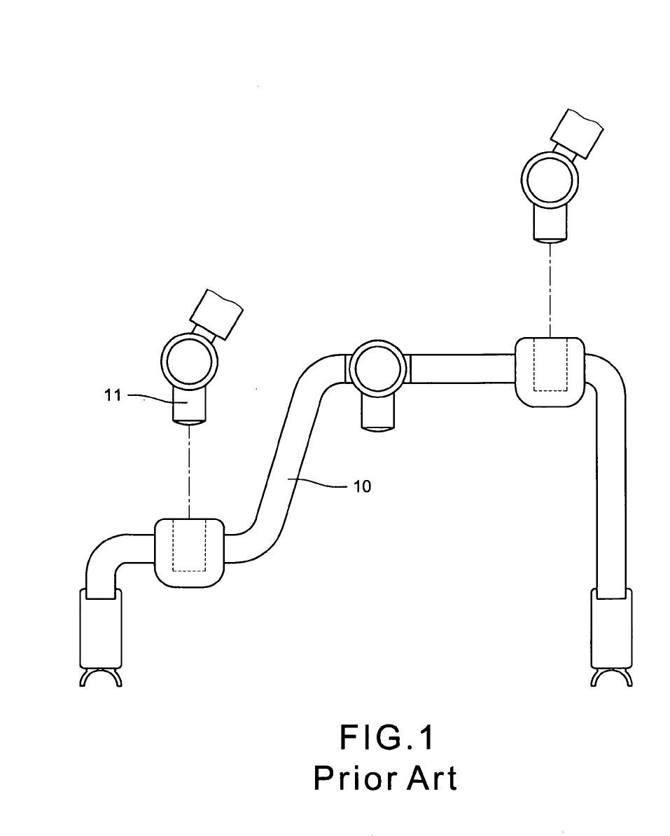

FIG. 2 is a top view to show the conventional dual-seat frame;

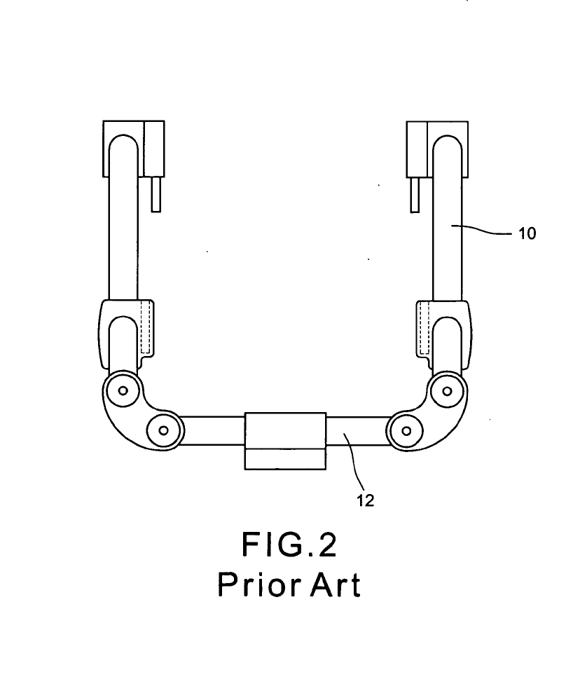

FIG. 3 shows that the conventional dual-seat frame is folded;

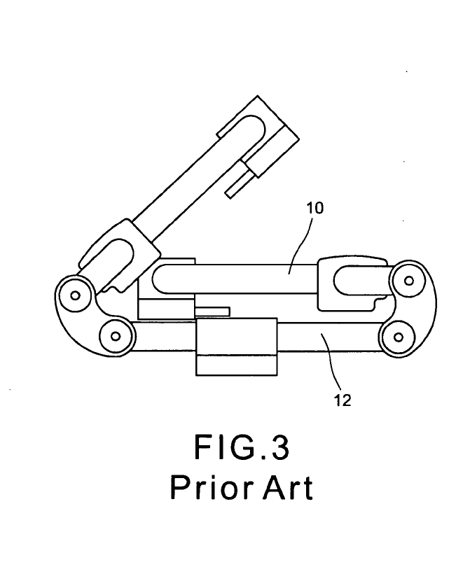

FIG. 4 is an exploded view to show the main frame of the baby stroller and the seat frame of the present invention;

FIG. 5 is a side view to show two seats are to be connected to the seat frame of the present invention;

FIG. 6 is a perspective view to show the dual-seat baby stroller with the seat frame of the present invention and two seats are connected to the seat frame of the present invention;

FIG. 7 is a perspective view to show the seat frame of the present invention of the present invention;

FIG. 8 is a top view to show the seat frame of the present invention;

FIG. 9 shows that the pivotal rods of the seat frame of the present invention are pivoted inward;

FIG. 10 is a perspective view to show the folded seat frame of the present invention, and

FIG. 11 is an exploded view to show the main frame of the baby stroller and the seat frame of the present invention, the front seat is arranged to face backward and the rear seat is arranged to face forward.

### DETAILED DESCRIPTION OF THE PREFERRED EMBODIMENTS

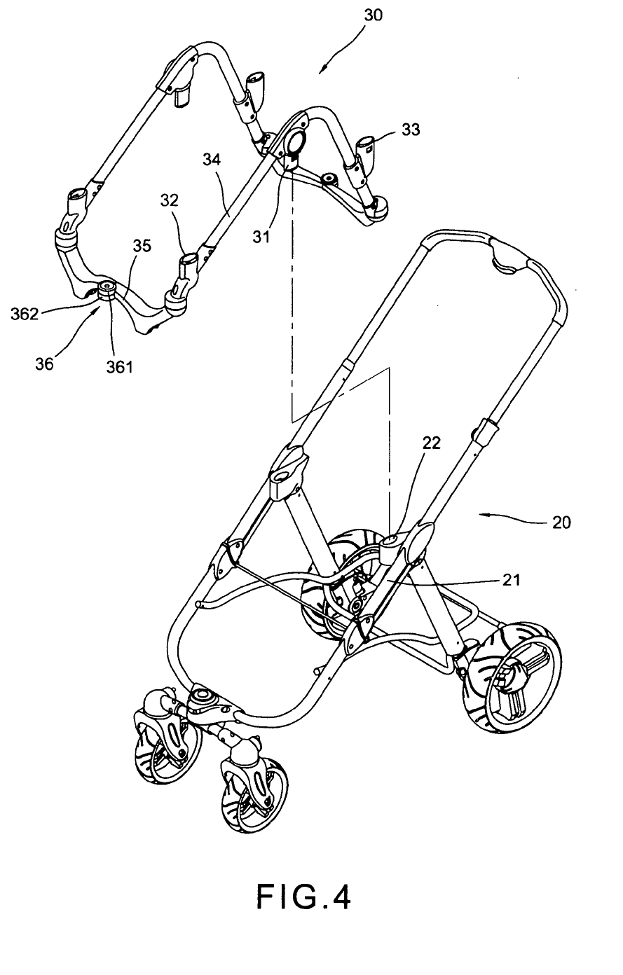

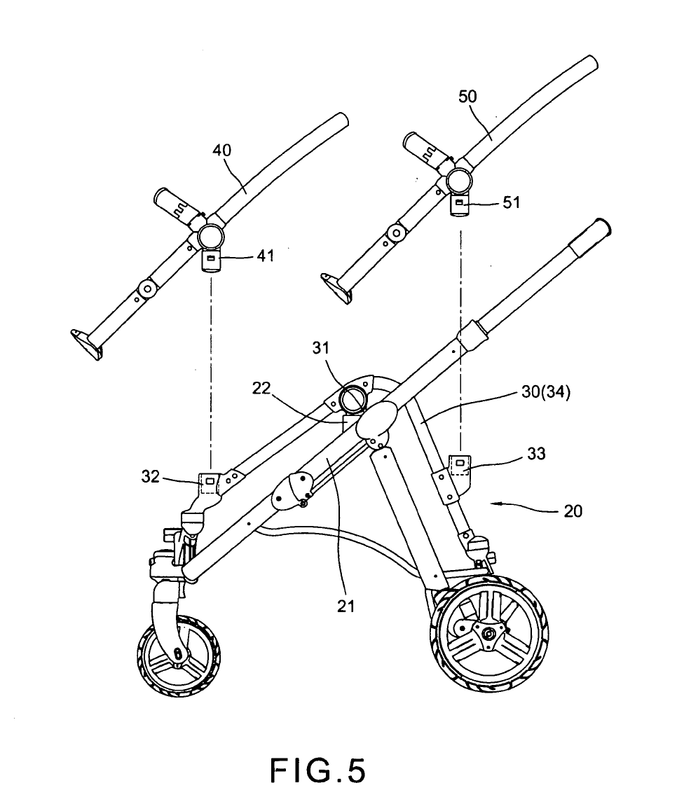

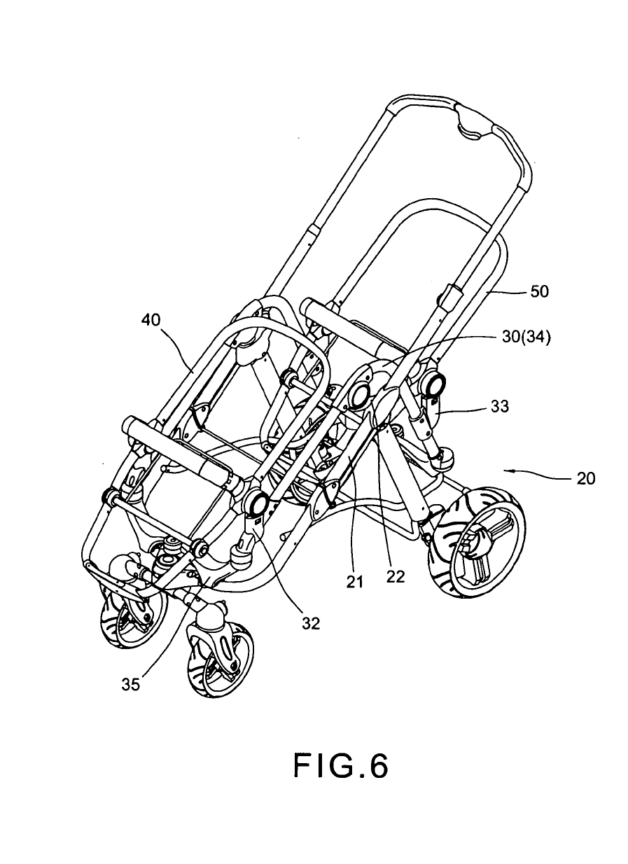

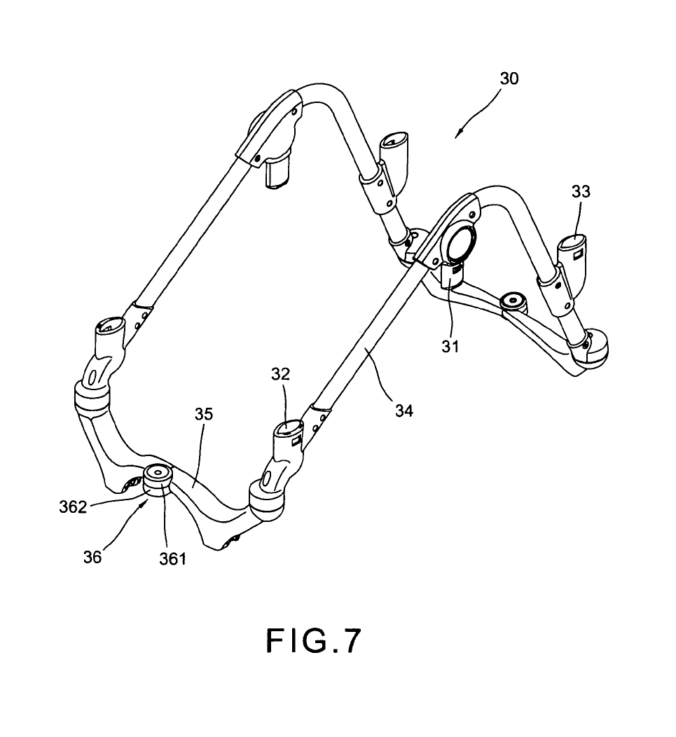

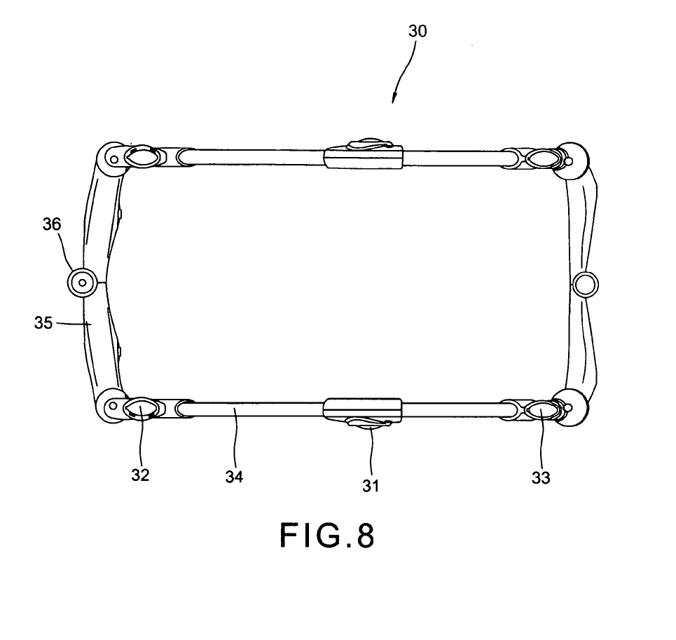

Referring to FIGS. 4 to 8, the dual-baby stroller of the present invention comprises a main frame 20 having two side frames 21 on two sides thereof, front and rear wheels are connected to the main frame 20. Two positioning members 22 are located on the two side frames 21.

A seat frame 30 is composed of two side rails 34 and two pivotal rods 35 which are connected between the two side rails 34. The two pivotal rods 35 are cooperated with two pivotable units 36 respectively such that the two pivotal rods 35 are pivoted inward about the pivotable units 36. The two pivotable units 36 can be any known pivotable unit, in this embodiment, the pivotable units 36 each are composed of two pivotable members 361, 362 pivotably connected to a common axis.

The two side rails 34 of the seat frame 30 are inverted V-shaped rails and two insertions 31 extend from a mediate portion of the two side rails 34. The two insertions 31 are removably connected to the two positioning members 22 on the main frame 20 so that the seat frame 30 is removably connected to the main frame 20. The two side rails 34 of the seat frame 30 are inverted V-shaped rails and each inverted V-shaped rail includes a front inclined section and a rear inclined section. The front reception members 32 are located close to two respective front ends of the front inclined sections and the rear reception members 33 are located at two respective mediate portions of the rear inclined sections. The rear reception members 33 are located higher than the front reception members 32.

The front seat 40 includes two insertions 41 which are p removably connected to the front reception members 32 and the rear seat 50 includes two insertions 51 which are removably connected to the rear reception members 33, so that the rear seat 50 will be located higher than the front seat 40 when they face the same direction.

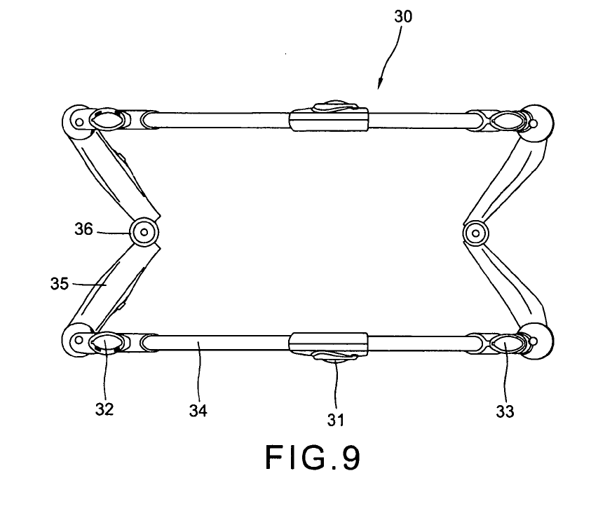

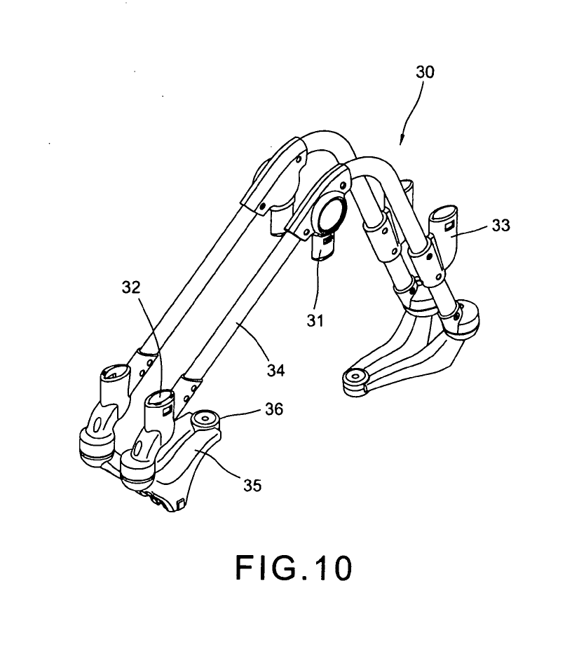

Referring to FIGS. 9 and 10, when folding the seat frame 30, the two pivotable units 36 allow the two pivotal rods 35 to be folded inward so as to move the two side rails 34 close toward each other.

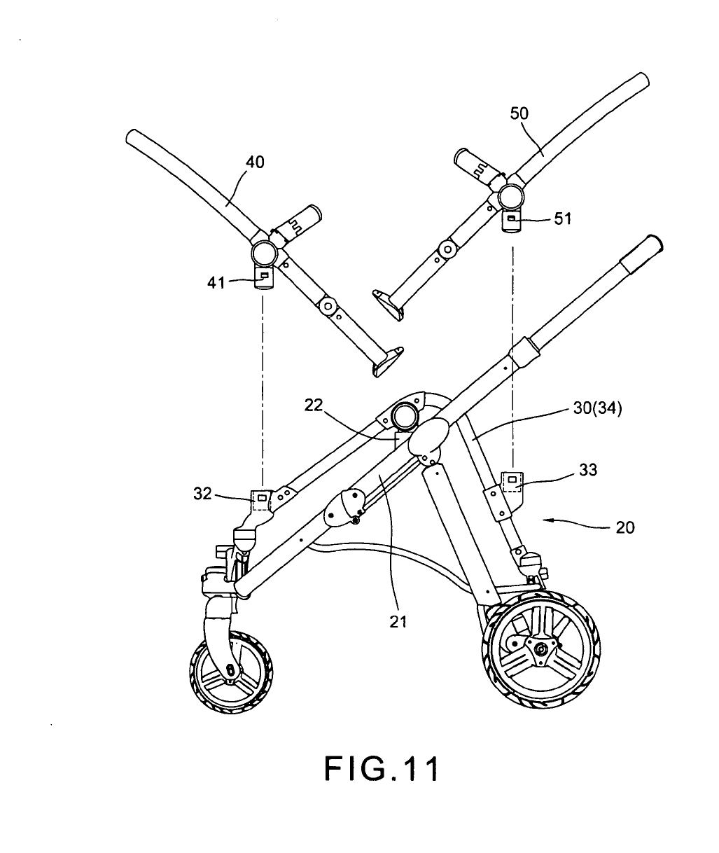

As shown in FIG. 11, the front seat 40 can also be arranged to face the second seat 50 without interference because the rear seat 50 is located higher than the front seat 40 and the distance between the front and rear seats 40, 50 is long enough.

It is noted that the front inclined section and the rear inclined section are located symmetrically so that when the front and rear seats 40, 50 are connected to the seat frame 30, the weight center will be located substantially at a center of the seat frame 30 and this is helpful to operate the baby stroller.

While we have shown and described the embodiment in accordance with the present invention, it should be clear to those skilled in the art that further embodiments may be made without departing from the scope of the present invention.

What is claimed is:

1. A dual-baby stroller comprising:
a main frame having two side frames on two sides thereof, front and rear wheels connected to the main frame, two positioning members located on the two side frames, and
a seat frame removably connected to the two positioning members and including two front reception members on a front portion of the seat frame and two rear reception members on a rear portion of the seat frame, the front reception members adapted to be connected with a front seat and the rear reception members adapted to be connected with a rear seat, the seat frame including two side rails and two pivotal rods which are connected between the two side rails, the two pivotal rods cooperated with two pivotable units respectively such that the two pivotal rods are pivoted inward about the pivotable units.

2. The stroller as claimed in claim 1, wherein the two side rails of the seat frame are inverted V-shaped rails and two insertions extend from a mediate portion of the two side rails, the two insertions are removably connected to the two positioning members on the main frame.

3. The stroller as claimed in claim 1, wherein the two side rails of the seat frame are inverted V-shaped rails and each inverted V-shaped rail includes a front inclined section and a rear inclined section, the front reception members are located close to two respective front ends of the front inclined sections and the rear reception members are located at two respective mediate portions of the rear inclined sections, the rear reception members are located higher than the front reception members.

4. The device as claimed in claim 1, wherein the two pivotable units each are composed of two pivotable members pivotably connected to a common axis.
